(19) United States
(12) Patent Application Publication
(10) Pub. No.: US 2023/0143334 A1
(43) Pub. Date: May 11, 2023

(54) MANUFACTURING DEVICE FOR ADDITIVE MANUFACTURING OF COMPONENT PARTS FROM A POWDER MATERIAL, METHOD FOR CHANGING A BEAM PROFILE OF AN ENERGY BEAM, AND USE OF AT LEAST ONE ACOUSTO-OPTIC DEFLECTOR

(71) Applicant: TRUMPF Laser- und Systemtechnik GmbH, Ditzingen (DE)

(72) Inventors: Matthias ALLENBERG-RABE, Lubwigsburg (DE); Valentin BLICKLE, Stuttgart (DE); Jonas GRUENEWALD, Munich (DE); Philipp WAGENBLAST, Leonberg (DE); Wilhelm MEINERS, Aachen (DE)

(21) Appl. No.: 18/149,169

(22) Filed: Jan. 3, 2023

Related U.S. Application Data
(63) Continuation of application No. PCT/EP2021/070413, filed on Jul. 21, 2021.

(30) Foreign Application Priority Data
Jul. 21, 2020 (DE) 102020209172.2
Oct. 9, 2020 (DE) 102020006217.2
Nov. 2, 2020 (DE) 102020128807.7
Nov. 24, 2020 (DE) 102020131032.3

(51) Int. Cl. B22F 10/366; B22F 12/41; B22F 12/49

(52) U.S. Cl. CPC B22F 10/366; B22F 12/41; B22F 12/49; B33Y 30/00

(57) ABSTRACT

A manufacturing device for additive manufacturing of a component part from a powder material includes a beam generating device configured to generate an energy beam, a scanner device configured to displace the energy beam to a plurality of irradiation positions in order to produce the component part from the powder material arranged in the work region using the energy beam, a deflection device configured to displace the energy beam to a plurality of beam positions at an irradiation position of the plurality of irradiation positions within a beam region, and a control device operatively connected to the deflection device and configured to control the deflection device and to change a beam profile of the beam region during production of a component part by changing a control of the deflection device.

### CROSS REFERENCE TO RELATED APPLICATIONS

This application is a continuation of International Application No. PCT/EP2021/070413 (WO 2022/018149 A1), filed on Jul. 21, 2021, and claims benefit to German Patent Applications No. DE 10 2020 209 172.2, filed on Jul. 21, 2020; DE 10 2020 006 217.2; filed on Oct. 09, 2020, DE 10 2020 128 807.7; filed on Nov. 02, 2020 and DE 10 2020 131 032.3; filed on Nov. 24, 2020. The aforementioned applications are hereby incorporated by reference herein.

### FIELD

The invention relates to a manufacturing device for additive manufacturing of component parts from a powder material, to a method for changing a beam profile of an energy beam, and to a use of at least one acousto-optic deflector.

### BACKGROUND

During the additive manufacturing of component parts from a powder material, an energy beam is typically displaced to predetermined irradiation positions of a work region—in particular along a predetermined irradiation path—in order to locally solidify powder material arranged in the work region. In particular, this is repeated layer-by-layer in powder material layers successively arranged in the work region in order to ultimately obtain a three-dimensional component part made of solidified powder material. In order to increase productivity and/or to design material properties of the resulting component part locally differently, it is desirable for different regions within the component part to be manufactured, in particular different regions within a same powder material layer in the work region, to be exposed to different beam profiles of the energy beam. Generating suitable, adapted beam profiles by means of conventional beam shaping, in particular by way of refractive or interferometric optical elements in the case of an optical energy beam, is frequently complex and not flexibly utilizable. In particular, it proves to be difficult or even virtually impossible to switch between different beam profiles during the individual production process and very particularly within a powder material layer. Moreover, conventional methods of beam shaping allow the realization of only a limited selection of beam profiles, and so their applicability is also limited.

An aspect of the present invention is to provide a manufacturing device for additive manufacturing of component parts from a powder material, a method for changing a beam profile of an energy beam on a work region of such a manufacturing device, and a use of at least one acousto-optic deflector, in the case of which the disadvantages mentioned are at least reduced, preferably avoided.

### SUMMARY

In an embodiment, the present disclosure provides a manufacturing device for additive manufacturing of a component part from a powder material that includes a beam generating device configured to generate an energy beam, a scanner device configured to displace the energy beam to a plurality of irradiation positions in order to produce the component part from the powder material arranged in the work region using the energy beam, a deflection device configured to displace the energy beam to a plurality of beam positions at an irradiation position of the plurality of irradiation positions within a beam region, and a control device operatively connected to the deflection device and configured to control the deflection device and to change a beam profile of the beam region during production of a component part by changing a control of the deflection device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an illustration of one exemplary embodiment of a manufacturing device for additive manufacturing of component parts from a powder material,

FIG. 2 shows a schematic illustration of a plurality of different shapes of a beam region, and

FIG. 3 shows a schematic diagram for explaining electro-optic deflection within the scope of additive manufacturing.

### DETAILED DESCRIPTION

In an aspect the present disclosure provides a manufacturing device for additive manufacturing of component parts from a powder material, comprising a beam generating device configured to generate an energy beam. The manufacturing device additionally comprises a scanner device configured to displace the energy beam to a plurality of irradiation positions within a work region in order to produce a component part by means of the energy beam from the powder material arranged in the work region. In addition, the manufacturing device comprises a deflection device configured to displace the energy beam to a plurality of beam positions at an irradiation position of the plurality of irradiation positions within a beam region. Furthermore, the manufacturing device comprises a control device operatively connected to the deflection device and configured to control the deflection device and to change a beam profile of the beam region during the production of a component part by changing the control of the deflection device.

In this way, in particular, a beam profile used can be predefined and changed easily and rapidly during the production of a component part, in particular during the processing of a same powder material layer, without this requiring special devices, in particular devices specific to the generation of the beam profile. In particular, it is easily and rapidly possible to switch between different beam profiles. The manufacturing device is consequently able with great flexibility to generate a suitable beam profile in a manner adapted to the locally prevailing requirements and/or conditions in each case, in particular the regions of the component part that are to be produced in each case. Consequently, the manufacturing device not only has a high productivity, but also enables a locally varying adjustment of the material properties of the resulting component part. As a result of this, in particular, it is possible to increase the quality of the component parts produced by the manufacturing device proposed here, in particular by the selection of particularly suitable beam profiles. Since there is no need for interferometric optical elements that are adapted specifically to the beam profiles, in particular refractive or static interferometric optical elements, the manufacturing device is designed cost-effectively, despite its high flexible applicability, especially in regard to the aspect that producing different beam profiles does not necessitate devices of different types which cause additional parts costs and between which it would be necessary to switch laboriously and in a time-consuming manner. The manufacturing device proposed here also allows, by means of suitable control of the scanner device and also of the deflection device, switching between the most efficient, in particular also rapid, component part manufacturing and particularly high-quality manufacturing, in particular also with locally varying adjustment of the material properties for the resulting component part, for example a greater hardness in the region of the component part surface than inside the component part.

In particular, the scanner device and also the deflection device allow a separation of the time and length scales relevant to the production of the resulting component part. While the scanner device is configured to displace the energy beam virtually globally along the plurality of irradiation positions, in particular along a predetermined irradiation path, over the entire work region at a longer time scale in comparison with the deflection device, the deflection device is configured to displace the energy beam virtually locally to the plurality of beam positions within the beam region at an irradiation position, which is virtually stationary on account of the time scale separation and which is predefined by the scanner device, at a shorter time scale relative to the time scale of the scanner device. On account of the time scale separation, a specific beam profile as geometric shape and as intensity profile of the beam region arises quasi-statically in this way virtually at each irradiation position of the plurality of irradiation positions. The beam profile generated in this way, in particular, is in turn displaced by the scanner device along the plurality of irradiation positions, in particular along the irradiation path. By changing the control of the deflection device, it is now advantageously possible to change the beam profile of the beam region, that is to say in particular the shape of the beam region and/or the intensity profile in the beam region, virtually as desired, where necessary even from irradiation position to irradiation position. In general, however, a plurality of adjacent irradiation positions, in particular in each case a continuous section of the irradiation path, are swept over by an identical beam profile. However, different sections of the irradiation path are preferably swept over by different beam profiles.

The beam profile generated is quasi-static in particular also in view of the melting process in the powder material, with the time scale for the deflection of the energy beam by the deflection device being significantly shorter than the characteristic interaction time between the energy beam and the powder material. Averaged over time, the dynamically generated beam profile thus interacts with the powder material like a statically generated profile.

Additive manufacturing of a component part is understood to mean in particular building up a component part from powder material layer by layer, in particular a powder-bed-based method for producing a component part in a powder bed, in particular a manufacturing method selected from a group consisting of selective laser sintering, laser metal fusion (LMF), direct metal laser melting (DMLM), laser net shaping manufacturing (LNMS), and laser engineered net shaping (LENS). Accordingly, the manufacturing device is configured in particular to carry out at least one of the aforementioned additive manufacturing methods.

In general, an energy beam is understood to mean directed radiation that is able to transport energy. In general, this may be particle radiation or wave radiation. In particular, the energy beam propagates through physical space along a propagation direction and transports energy along its propagation direction in the process. In particular, local deposition of energy in the work region is possible by means of the energy beam.

In a preferred configuration, the energy beam is an optical work beam. In particular, an optical work beam is understood to mean directed, either continuous or pulsed, electromagnetic radiation which, in terms of its wavelength or a wavelength range, is suitable for additive manufacturing of a component part from powder material, in particular for sintering or melting the powder material. In particular, an optical work beam is understood to mean a laser beam that can be generated continuously or in pulsed fashion. The optical work beam preferably has a wavelength or a wavelength range within the visible electromagnetic spectrum or within the infrared electromagnetic spectrum or within the overlap range between the infrared range and the visible range of the electromagnetic spectrum.

In particular, a work region is understood to mean a region, in particular a plane or surface, in which the powder material is arranged and is locally irradiated with the energy beam to locally solidify the powder material. In particular, the powder material is arranged sequentially in layers in the work region and locally irradiated with the energy beam in order to produce—layer by layer—a component part.

An irradiation position is understood to mean, in particular, a location within the work region at which energy is deposited locally into the work region, in particular into the powder material arranged there, by means of the energy beam. The scanner device is preferably configured to displace the energy beam within the work region along an irradiation path, wherein the irradiation path consists of a temporal sequence of irradiation positions over which the energy beam moves successively. In this case, the individual irradiation positions may be arranged spaced apart from one another, or may otherwise overlap. In particular, the irradiation path can be a path that is continuously scanned by the energy beam.

In particular, a beam region is here understood to mean a region at an irradiation position within which the specific intensity profile is generated. The beam region here has in particular a two-dimensional extent that is greater than a cross section of the energy beam projected onto the work region.

The deflection device is consequently configured in particular to displace the energy beam at a fixed irradiation position, in particular at each irradiation position, within the beam region and to thereby irradiate, at the fixed irradiation position, a specific region—the beam region—within the work region with the energy beam, said region being larger than the cross section of the energy beam projected onto the work region; by contrast, the scanner device is configured to displace the energy beam between the individual irradiation positions and thereby in turn to enable the deflection device to move the energy beam over a new beam region at a different location. The deflection device therefore serves for a local deflection of the energy beam at an irradiation position, while the scanner device serves for the global displacement of the energy beam within the work region.

The scanner device and the deflection device thus differ in particular—as already explained—with regard to the length scale of the possible displacement, wherein the scanner device is preferably configured to move the energy beam over the entire work region, wherein the deflection device is configured to deflect the energy beam locally at an irradiation position, predefined by the scanner device, within the beam region, with the respective beam region being very much smaller than the work region. In particular, the beam region preferably has a length scale in the range of a few (that is to say less than ten) millimeters to a few centimeters and preferably has a two-dimensional extent in the range of a few square millimeters to a few square centimeters, while the work region has a length scale in the range of a few decimeters to a few meters, and preferably a two-dimensional extent in the range of a few square decimeters to a few square meters.

The scanner device, on the one hand, and the deflection device, on the other hand, preferably also differ with regard to the time scale on which a deflection of the energy beam takes place: In particular, the deflection of the energy beam within the beam region by way of the deflection device preferably takes place on a shorter time scale, in particular a very much shorter time scale, than the deflection within the work region by way of the scanner device, that is to say than the change from one irradiation position to the next irradiation position. In this way, a specific beam profile can advantageously be generated quasi-statically by a suitable displacement of the energy beam within the beam region by means of the deflection device at each irradiation position predefined by an instantaneous setting of the scanner device. The time scale on which the energy beam can be deflected by the deflection device is preferably smaller by a factor of 10 to 1000, preferably 20 to 200, preferably 40 to 100, or more, than the time scale on which the energy beam is deflected by the scanner device.

The control device is preferably selected from a group consisting of a computer, more particularly a personal computer (PC), a plug-in card or control card, and an FPGA board. In a preferred configuration, the control device is an RTC6 control card from SCANLAB GmbH, in particular in the current configuration obtainable on the priority date of the present property right.

The control device is preferably configured to synchronize the scanner device with the deflection device by means of a digital RF synthesizer, wherein the RF synthesizer is controlled via a programmable FPGA board. Additionally, there is preferably a division into the comparatively slow movement of the scanner device and the fast movement of the deflection device by means of a frequency divider. Preferably, position values and predefined values for the beam profile are calculated, and these are then converted in the FPGA board into temporally synchronous frequency specifications for the RF synthesizer. Before doing so, a spatial allocation of the beam profiles to irradiation positions in the respective powder material layer is required, which is preferably performed already in a build processor. The latter writes the corresponding data into a file, which is then preferably used by the control device. Alternatively or additionally, it is preferably possible to select from predefined beam profiles.

One development of the invention provides for the deflection device to be configured to abruptly displace the energy beam to the plurality of beam positions, wherein the plurality of beam positions are discrete beam positions. In particular, it is possible for adjacent beam positions to be spaced apart from one another. However, it is also possible for adjacent beam positions to overlap one another at least regionally. The energy beam is advantageously not displaced continuously from beam position to beam position by the deflection device, but rather is displaced in particular in discrete steps. Without loss of generality and without wanting to be tied to theory, the assumption can be made for all practical application purposes that the energy beam virtually disappears at a first beam position and arises at a second beam position without in particular sweeping over intermediate regions in the case of the abrupt or discrete displacement from the first beam position to the second beam position. In this way, a very fast displacement of the energy beam is possible within the beam region, and material transport processes that are otherwise based on a continuous displacement of the energy beam can preferably be avoided, which increases the quality of the resulting component part.

One development of the invention provides for the control device to be configured to change, as beam profile, a shape of the beam region during the production of the component part. A shape of the beam region is understood here to mean in particular the geometry of an external boundary of the beam region or—equivalently—a shape of the surface over which the energy beam is swept quasi-statically within the beam region. This corresponds to a quasi-static cross-sectional profile of the energy radiation with which the work region is irradiated at the respective irradiation position.

Alternatively or additionally, the control device is preferably configured to change, as beam profile, an intensity profile in the beam region during the production of the component part. An intensity profile is understood here to mean in particular a surface power density distribution of the energy beam.

By changing the beam profile, in particular the shape of the beam region and/or the intensity profile, it is advantageously possible easily and rapidly to adapt the beam profile in line with requirements during the production of the component part.

One development of the invention provides for the control device to be configured to predefine the beam profile, in particular the shape of the beam region, depending on an instantaneous irradiation position within the component part to be produced, in particular within a same powder material layer. In particular, the control device is configured to predefine different beam profiles at different irradiation positions. In this way, the beam profile can advantageously be adapted flexibly and locally to different conditions or requirements.

For example, a different beam profile can be selected for an external enclosing region of the component part being produced, that is to say in particular for its surface, than for an internal region within the external enclosing region of the component part.

Alternatively or additionally, a different beam profile can be selected for a contour, that is to say a boundary or external delimitation of a region to be solidified, or solidified region, within a powder material layer, than for a so-called core, that is to say a region within the contour in the powder material layer.

Additionally or alternatively, yet another beam profile can be selected for an overhang region, where an overhang region is a region within a powder material layer below which, that is to say in underlying powder material layers, non-solidified powder material is situated. Such an overhang is also referred to as “down skin.” This term also denotes the lowermost powder material layer that comprises solidified powder material, that is to say a bottom surface of the component part.

Additionally or alternatively, yet another beam profile can be selected for a capping layer region, where a capping layer region is a region within a powder material layer above which, that is to say in overlying powder material layers, non-solidified powder material is situated. Such a capping layer region is also referred to as “up skin.” This term also denotes the uppermost powder material layer that still comprises solidified powder material, that is to say a roof surface or uppermost surface of the component part.

In particular, yet another beam profile can be selected for a volume region of the resulting component part, that is to say a region within a powder material layer which is surrounded by solidified powder material on all sides, in particular within the powder material layer, but also above and below the powder material layer just processed, in the completed component part. Such a region is also referred to as “in skin” region.

It is also possible to use different beam profiles for filigree structures of a component part which are for example of the order of magnitude of the beam region, and also for coarser, larger, in particular two-dimensional, structures. Optionally, filigree structures, in particular self-contained structure sections, can also be produced purely by controlling the deflection device and generating a local beam profile at a fixed irradiation position without the scanner device being controlled, in particular by virtue of a beam profile in the form of the structure section to be formed being generated by suitable control of the deflection device.

The predefinition of the beam profile depending on the instantaneous irradiation position also makes it possible to influence the resulting component part microstructure via the intensity distribution. For example, a grain structure of the resulting component part changes upon irradiation with changed temperature gradients and solidification conditions. It is possible in this way in particular also to influence, and in particular locally vary, local strength values or surface hardnesses.

In particular, it is possible to harden the outer surface of the component part by producing a greater hardness of the solidified powder material in up skin or down skin regions in a plurality of powder material layers that are arranged immediately therebelow or thereabove. Accordingly, it is also possible in individual powder material layers to solidify contour lines to a broader extent with greater hardness.

By contrast, an external enclosing region is, in particular, a region within a powder material layer which has at least one interface line with respect to non-solidified powder material within the powder material layer. Such an enclosing region may simultaneously be an overhang, but in the finished component part it may also be surrounded by solidified powder material above and below the powder material layer currently produced.

One development of the invention provides for the control device to be configured to predefine the shape of the beam region as a shape selected from a group consisting of: a rotationally symmetrical shape, in particular a shape with threefold rotational symmetry or higher-fold rotational symmetry, in particular a shape with C₃ rotational symmetry, a circle shape, a ring shape, a torus shape or donut shape, a polygon, a rectangle, an elongated shape, preferably having rounded corners, a line shape, an irregular shape, and a point shape. Larger shapes with greater two-dimensional extents are preferably used to manufacture internal in-skin regions and/or core regions and/or inner regions of the component part rapidly and thus with high productivity, wherein more filigree, smaller shapes are preferably used to process in particular filigree or detailed enclosing regions or overhangs.

The control device is preferably configured to switch or change over between at least two different shapes of the beam region.

One development of the invention provides for the control device to be configured to generate the intensity profile as a Gaussian intensity profile. In particular, this can also be a Gaussian profile that is elongated along a direction within the work region, wherein the axis of longest extent of the Gaussian profile in a preferred configuration can extend perpendicularly to an irradiation path, that is to say an in particular local displacement direction of the energy beam in the work region, or alternatively along the irradiation path of the energy beam, i.e. in the displacement direction. It is of course also possible, however, for the axis of longest extent of the Gaussian profile to extend obliquely with respect to the irradiation path.

Alternatively, the control device is preferably configured to generate the intensity profile as a non-Gaussian intensity profile.

Alternatively or additionally, the control device is configured to generate the intensity profile as a constant intensity profile, in particular in the manner of a flat-top beam.

Alternatively or additionally, the control device is configured to generate the intensity profile as an asymmetric or distorted intensity profile. The control device is therefore preferably able to generate a multiplicity of different intensity profiles, in particular any desired intensity profiles, and to switch between them.

One development of the invention provides for the control device to be configured to predefine the beam profile, in particular the shape of the beam region, depending on an instantaneous irradiation position within the component part to be produced, in particular within a same powder material layer, in such a way that the beam profile projected on the work region corresponds to a predefined projected beam profile.

This solves the problem of the beam profile being distorted upon non-perpendicular incidence on the powder material in the work region. In this regard, e.g. a circular beam profile which is incident on the powder material at an angle to the surface normal of the powder material in the work region is distorted to an ellipse. Accordingly, for the beam profile an ellipse can be predefined in such a way that the beam profile projected on the powder material is circular again.

In one preferred development, the control device is configured to distort the predefined beam profile in such a way that the projected beam profile corresponds to one of the beam profiles mentioned in the previous developments.

One development of the invention provides for the deflection device to be arranged upstream of the scanner device in the direction of propagation of the energy beam. In this case, the direction of propagation of the energy beam is, in particular, a propagation direction of the energy radiation in space. The term “upstream” refers to the fact that the deflection device is reached first by the energy beam during the propagation of the energy beam along the direction of propagation, with the scanner device being reached by the energy beam thereafter. The arrangement of the deflection device upstream of the scanner device in the direction of propagation constitutes a particularly suitable configuration for flexible generation of the beam profile.

One development of the invention provides for the deflection device to comprise at least one acousto-optic deflector.

An acousto-optic deflector is understood here to mean in particular an element with a solid body which is transparent to the energy beam and to which acoustic waves, in particular ultrasonic waves, can be applied, with the energy beam being deflected upon passage through the transparent solid body, in a manner dependent on the frequency of the acoustic waves applied to the transparent solid body. In the process, an optical grating, in particular, is generated by the acoustic waves within the transparent solid body. Advantageously, such acousto-optic deflectors are able to very rapidly deflect the energy beam within an angular range predefined by the frequency of the acoustic waves generated within the transparent solid body. In particular, switching speeds of up to 1 MHz can be attained in the process. In particular, the switching times for such an acousto-optic deflector are significantly faster than typical switching times for conventional scanner optical units, in particular galvanometer scanners, which are generally used to displace an energy beam within a work region of a manufacturing device of the type under discussion here. Therefore, such an acousto-optic deflector can be used particularly suitably to generate a quasi-static beam profile in the beam region.

Modern acousto-optic deflectors deflect the energy beam into a predetermined angular range of the first order of diffraction with an efficiency of at least 90%, and so they are eminently suitable as a deflection device for the manufacturing device proposed here. In particular, the employed material that is transparent to the energy beam and a suitably high intensity of the input-coupled ultrasonic waves are crucial for the high efficiency.

In a preferred configuration, the deflection device has two acousto-optic deflectors oriented non-parallel to one other, preferably oriented perpendicularly to one other. It is thus advantageously possible to deflect the energy beam in two directions that are not parallel to one another, in particular directions that are perpendicular to one another. The acousto-optic deflectors non-parallel to one another are preferably arranged one downstream of another in the direction of propagation of the energy beam.

Here “downstream” is taken to mean, in particular, that one element arranged downstream of another element is reached by the energy beam after the other element during a propagation of the energy beam along the direction of propagation, analogously to the definition for “upstream” given above.

One development of the invention provides for the manufacturing device to comprise a separation mirror downstream of the deflection device and upstream of the scanner device in the direction of propagation of the energy beam, in order to separate a zeroth order partial beam of the energy beam from a first order partial beam. Especially if the deflection device comprises an acousto-optic deflector, it generates, on account of its configuration analogous to an optical grating, a non-diffracted zeroth order partial beam and a diffracted or deflected first order partial beam. Only the first order partial beam is intended to be used to irradiate the work region. With the aid of the separation mirror, it is then advantageously possible to separate the partial beams of different orders from one another and in so doing to transmit only the first order partial beam to the work region, in particular to the scanner device. The zeroth order partial beam is preferably diverted into a beam trap by the separation mirror.

This explanation is correct for the use of exactly one acousto-optic deflector. If, in a preferred configuration, two acousto-optic deflectors oriented non-parallel to one another, preferably oriented perpendicularly to one another, are used, then the corresponding orders of diffraction should also be considered cumulatively: As useful beam, the intention ultimately is to use the partial beam which initially impinges as first order partial beam of the first acousto-optic deflector on the second acousto-optic deflector, and is then diffracted once again as first order partial beam by the second acousto-optic deflector. In this case, the useful beam as “first order partial beam” is as it were a first first order partial beam. In order to keep the explanation simple, reference is nevertheless only ever made to the first order hereinafter.

In particular, the separation mirror preferably comprises a passage hole in a surface that is reflective for the energy beam, through which passage hole the first order partial beam passes the separation mirror toward the work region, in particular toward the scanner device. By contrast, the zeroth order partial beam—and preferably also unwanted partial beams of higher order than the first order—impinge on the reflective surface and are diverted into the beam trap by the separation mirror.

Preferably, the separation mirror is arranged in the vicinity of an intermediate focus of a telescope. This enables the partial beams of different orders to be separated particularly cleanly.

Preferably, the separation mirror is not arranged exactly at the intermediate focus of the telescope, in particular in order to avoid damage to the separation mirror as a result of an excessively high power density of the energy beam.

Preferably, the separation mirror is arranged offset along the direction of propagation at a distance of one fifth of the focal length of the telescope with respect to the intermediate focus, preferably upstream of the intermediate focus in the direction of propagation. This simultaneously ensures, firstly, a clean separation of the different partial beams of different orders and, secondly, a sufficiently low power density of the energy beam on the separation mirror in order to avoid damage thereto resulting from the energy beam.

The telescope is preferably a 1:1 telescope, i.e. has in particular neither a beam-reducing nor a beam-magnifying property. In particular, the telescope fulfills two tasks, namely besides the separation of the different partial beams of different orders also preferably additionally the imaging of a beam rotation point, also referred to as pivot point, onto a point downstream of the telescope in the direction of propagation, the imaged beam rotation point preferably arriving either at a pivot point of the downstream scanner device or at a point of smallest aperture.

This consideration, too, strictly speaking, is applicable only to the use of a single acousto-optic deflector. If two acousto-optic deflectors oriented non-parallel to one another, preferably oriented perpendicularly to one another, are used, two beam rotation points arise, namely one beam rotation point in each acousto-optic deflector. However, if the two acousto-optic deflectors are arranged as close as possible one downstream of another in the direction of propagation, to a good approximation a single, imaginary common beam rotation point can be assumed, which is then arranged between the acousto-optic deflectors.

One development of the invention provides for the deflection device to comprise at least one electro-optic deflector, preferably two electro-optic deflectors oriented non-parallel, in particular perpendicularly, to one another. The deflection of electro-optic deflectors (EOD) is based on refraction upon passage through an optically transparent material. Using one or two EODs it is possible to modify the abovementioned exemplary embodiments with acousto-optic deflectors by replacing in each case one or two of the acousto-optic deflectors with an EOD.

One development of the invention provides for the scanner device to comprise at least one scanner, in particular a galvanometer scanner, a piezo-scanner, a polygon scanner, a MEMS scanner, and/or a work head or processing head that is displaceable relative to the work region. The scanner devices proposed here are especially suitable for displacing the energy beam between a plurality of irradiation positions within the work region.

A work head or processing head that is displaceable relative to the work region is understood here to mean in particular an integrated component part of the manufacturing device which comprises at least one radiation outlet for at least one energy beam, the integrated component part, that is to say the work head, as a whole being displaceable along at least one displacement direction, preferably along two mutually perpendicular displacement directions, relative to the work region. Such a work head can in particular be embodied with a gantry design or be guided by a robot. In particular, the work head can be embodied as a robot hand of a robot.

One development of the invention provides for the beam generating device to be embodied as a laser. The energy beam is thus advantageously generated as an intensive beam of coherent electromagnetic radiation, in particular coherent light.

One development of the invention provides for the manufacturing device to be configured for selective laser sintering. Alternatively or additionally, the manufacturing device is configured for selective laser melting. These configurations of the manufacturing device have proved to be particularly advantageous.

The object is also achieved by providing a method for changing a beam profile of an energy beam on a work region of a manufacturing device during additive manufacturing of a component part from a powder material, wherein the energy beam is displaced to a plurality of irradiation positions within the work region in order to produce the component part by means of the energy beam from the powder material arranged in the work region. The energy beam is displaced to a plurality of beam positions at at least one irradiation position of the plurality of irradiation positions within a beam region. The beam profile is changed by changing the displacement of the energy beam in the beam region. In particular the advantages that have already been explained in connection with the manufacturing device are afforded in connection with the method.

One development of the invention provides for the beam profile, in particular the shape of the beam region, to be changed depending on an instantaneous irradiation position within the component part to be produced, in particular within a same powder material layer, wherein in particular different beam profiles are generated at different irradiation positions.

One development of the invention provides for the beam profile, in particular the shape of the beam region, to be changed depending on an instantaneous irradiation position within the component part to be produced, in particular within a same powder material layer, in such a way that the beam profile projected on the work region corresponds to a predefined projected beam profile. The same advantages that have already been explained in connection with the manufacturing device are afforded in connection with this method.

Finally, the object is also achieved by specifying a use of at least one acousto-optic deflector, wherein the acousto-optic deflector is used for changing a beam profile of an energy beam on a work region of a manufacturing device during additive manufacturing of a component part from a powder material, in particular within a same powder material layer. In particular those advantages which have already been explained in connection with the manufacturing device and the method are afforded in connection with the use of the acousto-optic deflector.

In a preferred configuration, the acousto-optic deflector is used in a method according to the invention for changing a beam profile of an energy beam or in one of the preferred embodiments of such a method described above.

Preferably, the acousto-optic deflector is used in a manufacturing device according to the invention or in a manufacturing device according to one of the exemplary embodiments of such a manufacturing device described above.

One development of the invention provides for two acousto-optic deflectors oriented in particular non-parallel to one another, preferably oriented perpendicularly to one another, to be used in order to change the beam profile of the energy beam. It is thus possible, particularly easily and rapidly, to change the beam profile in two directions preferably oriented non-parallel to one another, preferably oriented in particular perpendicularly to one another.

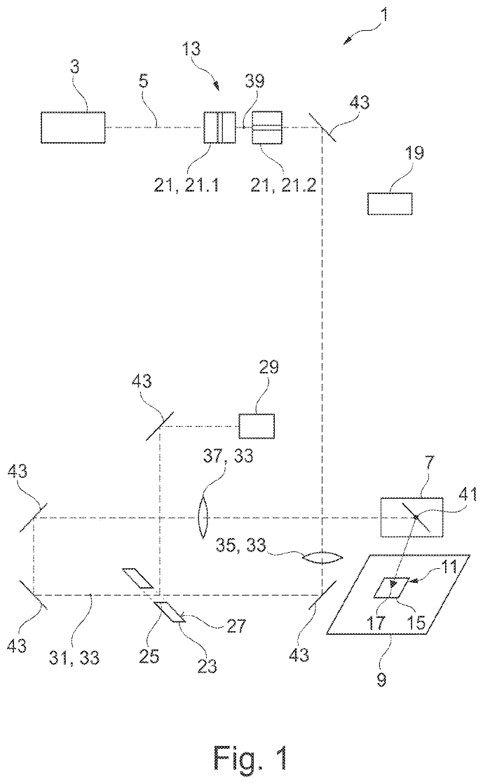

FIG. 1 shows a schematic illustration of one exemplary embodiment of a manufacturing device 1 configured for additive manufacturing of component parts from a powder material. The manufacturing device 1 comprises a beam generating device 3 configured to generate an energy beam 5. The manufacturing device 1 additionally comprises a scanner device 7 configured to displace the energy beam 5 to a plurality of irradiation positions 11 within a work region 9 in order to produce a component part by means of the energy beam 5 from the powder material arranged in the work region 9.

The manufacturing device 1 comprises a deflection device 13 configured to displace the energy beam 5 to a plurality of beam positions 17 at an irradiation position 11 of the plurality of irradiation positions 11 within a beam region 15.

The manufacturing device 1 comprises a control device 19 operatively connected to the deflection device 13 and configured to control the deflection device 13 and to change a beam profile of the beam region 15 during the production of the component part by changing the control of the deflection device 13.

In this way, it is possible, easily and extremely flexibly, for a beam profile used to be predefined and changed easily and rapidly during the production of a component part, in particular during the processing of a same powder material layer, without this requiring special devices, in particular devices specific to the generation of the beam profile. In particular, it is easily and rapidly possible to switch between different beam profiles.

In particular, the deflection device 13 is configured to abruptly displace the energy beam 5 to the plurality of beam positions 17, the beam positions 17 being discrete beam positions 17.

In particular, the control device 19 is configured to change, as beam profile, a shape of the beam region 15 and/or an intensity profile in the beam region 15 during the production of the component part.

In particular, the control device 19 is configured to predefine the beam profile, in particular the shape of the beam region 15, depending on an instantaneous irradiation position 11 within the component part to be produced. In a preferred configuration, the control device 19 is configured to predefine different beam profiles at different irradiation positions 11. In particular, this can be carried out within a same powder material layer, for example in order to expose different regions of the powder material layer, in particular an enclosing region, on the one hand, and an inner region, on the other hand, to different beam profiles. Alternatively or additionally, the beam profile can be selected in particular depending on whether a contour, a core, an overhang region, a capping layer region, or a volume region of the component part being produced is processed.

Preferably, the control device 19 is configured to predefine the shape of the beam region 15 as a shape selected from a group consisting of: a rotationally symmetrical shape, in particular a shape with threefold rotational symmetry or higher-fold rotational symmetry, a circle shape, a ring shape, a torus shape or donut shape, a polygon, a rectangle, an elongated shape, preferably having rounded corners, a line shape, an irregular shape, and a point shape. In particular, the control device 19 is configured to switch or change over between different shapes of the beam region 15.

In particular, the control device 19 is configured to generate the intensity profile as a Gaussian, non-Gaussian, constant, asymmetric or distorted intensity profile.

The deflection device 13 is arranged in particular upstream of the scanner device 7 in the direction of propagation of the energy beam 5.

In particular, the deflection device 13 comprises at least one acousto-optic deflector 21, in this case in particular two acousto-optic deflectors 21 oriented non-parallel, in particular perpendicularly, to one another, specifically a first acousto-optic deflector 21.1 and a second acousto-optic deflector 21.2. The acousto-optic deflectors 21 oriented perpendicularly to one another allow a deflection of the energy beam 5 in two mutually perpendicular directions and hence, in particular, allow two-dimensional scanning of the beam region 15.

The manufacturing device 1 additionally comprises a separation mirror 23 downstream of the deflection device 13 and upstream of the scanner device 7 in the direction of propagation of the energy beam 5, said separation mirror being configured to separate a zeroth order partial beam from a first order partial beam of the energy beam 5. To this end, the separation mirror 23 comprises a passage hole 25, in particular, which is provided in a surface 27 of the separation mirror 23 that is reflective for the energy beam 5 and which completely penetrates through the separation mirror 23. The first order partial beam that is intended to be transmitted to the scanner device 7 in a desired manner is guided through the passage hole 25 in this case and thus finally arrives at the scanner device 7. The unwanted zeroth order partial beam and optionally also unwanted higher order partial beams, by contrast, impinge on the reflective surface 27 and are diverted to a beam trap 29.

In particular, the separation mirror 23 is arranged in the vicinity of an intermediate focus 31 of a telescope 33, in particular not exactly in a plane of the intermediate focus 31, particularly preferably offset along the direction of propagation at a distance of one fifth of the focal length of the telescope 33, in particular upstream of the intermediate focus 31. Advantageously, this prevents the reflective surface 27 from being impinged on by an excessively high power density of the energy beam 5.

The telescope 33 preferably comprises a first lens 35 and a second lens 37. It is preferably designed as a 1:1 telescope. Preferably, the telescope 33 has a focal length of 500 mm.

The functionality of the telescope 33 is preferably twofold: Firstly, the telescope 33 enables a particularly advantageous and clean separation of the different orders of the energy beam 5 deflected by the deflection device 13, especially in the case of the arrangement of the separation mirror 23 chosen here; secondly, the telescope 33 preferably images an imaginary, common beam rotation point 39 of the deflection device 13 advantageously onto a pivot point 41 of the scanner device 7.

Alternatively, the telescope 33 preferably images the beam rotation point 39 onto a point of smallest aperture.

To facilitate a compact arrangement of the manufacturing device 1, the energy beam 5 is preferably diverted a number of times by diverting mirrors 43.

The scanner device 7 preferably comprises at least one scanner, in particular a galvanometer scanner, a piezo-scanner, a polygon scanner, a MEMS scanner and/or a work head.

The beam generating device 3 is preferably embodied as a laser.

The manufacturing device 1 is preferably configured for selective laser sintering and/or for selective laser melting.

In the context of a method for changing a beam profile of an energy beam 5 on a work region 9 of a manufacturing device 1 during additive manufacturing of a component part from a powder material, the energy beam 5 is preferably displaced to a plurality of irradiation positions 11 within the work region 9 in order to produce the component part by means of the energy beam 5 from the powder material arranged in the work region 9. The energy beam 5 is displaced to a plurality of beam positions 17 at at least one irradiation position 11 of the plurality of irradiation positions 11 within a beam region 15. The beam profile is changed by changing the displacement of the energy beam 5 in the beam region 15.

Preferably, the beam profile, in particular the shape of the beam region 15, is changed depending on an instantaneous irradiation position 11 within the component part to be produced, in particular within a same powder material layer, wherein in particular different beam profiles are generated at different irradiation positions 11.

In the context of a use of at least one acousto-optic deflector 21, the latter is used for changing a beam profile of an energy beam 5 on a work region 9 of a manufacturing device 1 during additive manufacturing of a component part from a powder material.

Preferably, in this case, two acousto-optic deflectors 21.1, 21.2 oriented in particular non-parallel, in particular perpendicularly, to one another are used.

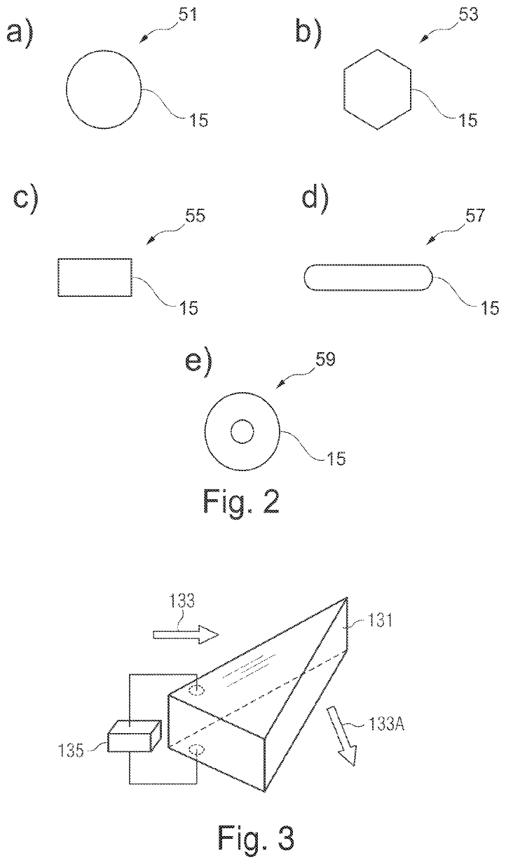

FIG. 2 shows a schematic illustration of a plurality of shapes of the beam region 15.

In this case, a first, circular shape 51 for the beam region 15 is illustrated at a).

A second, polygonal, here in particular hexagonal, shape 53 for the beam region 15 is illustrated at b).

A third, rectangular shape 55 for the beam region 15 is illustrated at c).

A fourth, elongated shape 57 for the beam region 15 having rounded ends is illustrated at d).

Finally, a fifth, ring-shaped, torus-shaped or donut-shaped shape 59 for the beam region 15 is illustrated at e).

FIG. 3 schematically shows an adjustable deflection of the energy beam 5 using an EOD 131, with the optically transparent material of the EOD 131 being adjustable in terms of refractive index or in terms of a refractive index gradient by way of the application of a voltage. The deflection of a laser beam 133 varies depending on the applied voltage, said laser beam preferably again being incident on the EOD 131 at the Brewster angle and emerging from said EOD at a correspondingly adjustable deflection angle. A laser beam 133A deflected thus could be fed to the scanner device 7 in the arrangement of FIG. 1. A voltage source 135 enables a precise adjustment of the voltage, which is applied, for example, between the upper and lower sides of the prism-shaped crystal forming the EOD 131 in FIG. 3. The refractive index or the refractive index gradient, and hence the deflection of the energy beam 5, can be set depending on the set voltage. With regard to the refraction behavior present at the EOD, reference is supplementarily made to “Electro-optic and acousto-optic laser beam scanners”; Römer G. R. B. E. et al., Physics Procedia 56 (2014) 29-39.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A manufacturing device for additive manufacturing of a component part from a powder material, the device comprising
a beam generating device configured to generate an energy beam,
a scanner device configured to displace the energy beam to a plurality of irradiation positions in order to produce the component part from the powder material arranged in the work region using the energy beam,
a deflection device configured to displace the energy beam to a plurality of beam positions at an irradiation position of the plurality of irradiation positions within a beam region, and
a control device operatively connected to the deflection device and configured to control the deflection device and to change a beam profile of the beam region during production of a component part by changing a control of the deflection device.

2. The manufacturing device as claimed in claim 1, wherein the deflection device is configured to abruptly displace the energy beam to the plurality of discrete beam positions.

3. The manufacturing device as claimed in claim 1, wherein the control device is configured to change a shape of the beam region and/or an intensity profile in the beam region during the production of the component part.

4. The manufacturing device as claimed in claim 1, wherein the control device is configured to predefine the beam profile depending on an instantaneous irradiation position within the component part to be produced.

5. The manufacturing device as claimed in claim 3, wherein the control device is configured to predefine the shape of the beam region as a shape selected from a group consisting of: a rotationally symmetrical shape a circle shape, a ring shape, a torus shape, a polygon, a rectangle, an elongated shape, a line shape, an irregular shape, and a point shape.

6. The manufacturing device as claimed in claim 3, wherein the control device is configured to generate the intensity profile as a Gaussian, non-Gaussian, constant, asymmetric or distorted intensity profile.

7. The manufacturing device as claimed in claim 1, wherein the control device is configured to predefine the beam profile depending on an instantaneous irradiation position within the component part to be produced in such a way that the beam profile projected on the work region corresponds to a predefined projected beam profile.

8. The manufacturing device as claimed in claim 1, wherein the deflection device is arranged upstream of the scanner device in a direction of propagation of the energy beam.

9. The manufacturing device as claimed in claim 1, wherein the deflection device comprises at least one acousto-optic deflector.

10. The manufacturing device as claimed in claim 1, wherein the deflection device comprises at least one electro-optic deflector.

11. The manufacturing device as claimed in claim 1, wherein the scanner device comprises at least one of a galvanometer scanner, a piezo-scanner, a polygon scanner, a MEMS scanner, and/or a work head that is displaceable relative to the work region,

12. The manufacturing device as claimed in claim 1, wherein the beam generating device includes a laser.

13. The manufacturing device as claimed in claim 1, wherein the additive manufacturing includes selective laser sintering and/or for selective laser melting.

14. A method for changing a beam profile of an energy beam on a work region of a manufacturing device during additive manufacturing of a component part from a powder material, the method comprising:
displacing the energy beam to a plurality of irradiation positions within the work region in order to produce the component part from the powder material arranged in the work region, wherein the energy beam is displaced to a plurality of beam positions at at least one irradiation position of the plurality of irradiation positions within a beam region, and
changing a displacement of the energy beam in the beam region so as to change the beam profile.

15. The method as claimed in claim 14, wherein the beam profile is changed depending on an instantaneous irradiation position within the component part to be produced, wherein different beam profiles are generated at different irradiation positions.

16. The method as claimed in claim 14, wherein the beam profile is changed depending on an instantaneous irradiation position within the component part to be produced in such a way that the beam profile projected on the work region corresponds to a predefined projected beam profile.

17. The method as claimed in claim 14, wherein the changing of the beam profile is performed using at least one acousto-optic deflector.

18. The method as claimed in claim 17, wherein at least one acoustic-optic deflector includes two acousto-optic deflectors oriented non-parallel to one another.
